(19) United States
(12) Patent Application Publication
(10) Pub. No.: US 2005/0098644 A1
(43) Pub. Date: May 12, 2005

(54) VEHICLE COOLING AND HEATING DEVICE

(76) Inventor: Ngy Srun Ap, Saint Remy Les Cheuvreuse (FR)

Correspondence Address: Valeo;Intellectual Property Department, 4100 North Atlantic Boulevard, Auburn Hills, MI, 48326, US

(21) Appl. No.: 10/467,228

(22) PCT Filed: Feb. 1, 2002
(86) PCT No.: PCT/FR02/00424

(30) Foreign Application Priority Data
Feb. 6, 2001 (FR) 01/01589

(51) Int. Cl. B60H 1/02

(52) U.S. Cl. 237/12.3 B

(57) ABSTRACT

The invention concerns a device comprising, additionally to the main thermostat (6) for interrupting the circulation of the refrigerant in the cooling radiator (2) to accelerate the heat engine (1) heating for a cold start, a three-way valve (10) which, when the temperature rises above the threshold opening the main thermostat (6), enables to gradually reduce the fluid flow rate in the heating radiator (3) then to cancel it so as to increase the fluid flow rate in the cooling radiator and consequently enhance the engine cooling efficiency.

The invention relates to a device for cooling the heat engine and heating the passenger compartment of a motor vehicle, comprising a first heat exchanger suitable for contributing to a transfer of heat from a heat transfer fluid to the atmosphere, a second heat exchanger suitable for contributing to a transfer of heat from the heat transfer fluid to the passenger compartment, a pump suitable for making the fluid flow in the engine and in two branches in parallel respectively containing the first and second exchangers, and switching means, which enable the fluid driven by the pump to flow or not to flow in each of said exchangers, the switching means comprising a first valve suitable for preventing flow of the fluid in the first exchanger when its temperature is lower than a first threshold and for allowing it when said temperature is higher than the first threshold.

A temperature of the heat transfer fluid lower than the first threshold, which is 80° C. for example, means that the engine is itself at a temperature too low to have optimum operating characteristics. To allow the engine to pass through this initial heating phase as quickly as possible, it is advisable to prevent the heat transfer fluid from flowing in the first heat exchanger so as to be cooled there. This is the function of the first valve.

It is an object of the invention to optimize the conditions of flow of the fluid in the second exchanger.

In particular, the invention has as its object a device of the type defined at the outset and envisages that the switching means furthermore comprise a second valve suitable for providing a cross section of passage for flow of the fluid in the second exchanger that depends on the temperature of the fluid: at its maximum below a second threshold higher than the first threshold and decreasing progressively between the second threshold and a third threshold higher than the latter, and zero above the third threshold.

When the temperature of the fluid exceeds the second threshold, it is possible to reduce its throughput in the second exchanger while at the same time satisfying any need for heating of the passenger compartment, thus reducing the noise pollution resulting from flow in this exchanger. The third threshold represents a limit which is reached only in exceptional engine load conditions, e.g. when the vehicle is towing a caravan up a long uphill slope, and which it is desirable to exceed as little as possible so as to avoid deterioration in the engine or in its performance. To do this, the flow of the fluid in the second exchanger is stopped and the entire output of the pump passes through the first exchanger, which provides a higher cooling capacity than the second exchanger.

Optional characteristics of the invention, which are complementary or alternatives, are stated below:
The second valve is a three-way valve, in which said variable cross section of passage is situated between first and second channels connected respectively to the engine and the second exchanger, and is suitable for allowing a flow of fluid between the third channel, which is connected to a bypass conduit, and either the first or the second channel only when the temperature of the fluid is lower than the third threshold.
The flow of fluid between the third channel and either the first or the second channel is allowed only when the temperature of the fluid is between the second and third thresholds.
The first channel is an inlet and the second and third channels are outlets or vice versa.
The flow of fluid between the third channel and either the first or the second channel is allowed even when the temperature of the fluid is lower than the second threshold.
The first and second channels are inlets and the third channel is an outlet or vice versa.
The three-way valve has a movable member which is displaced between extreme first and second positions when the temperature of the fluid varies between the second and third thresholds, said movable member including a first closing element, which isolates the first channel from the two other channels, and a second closing element, which isolates the third channel from the two other channels, in the second position, the closing elements opening the corresponding channels when not in the second position.
The movable member includes a third closing element, which isolates the third channel from the two other channels in the first position and opens it when not in the first position.
The second valve is furthermore suitable for preventing flow of the fluid in the second exchanger when the two following conditions are satisfied: temperature of the fluid lower than the first threshold and no demand for heating of the passenger compartment.
The second valve contains a medium which is in thermal contact with the heat transfer fluid and the thermal expansion of which causes the displacement of the movable member, means being provided to heat said medium independently of the temperature of the fluid so as to move the movable member into its second position in response to said two conditions.
The means for heating said medium comprise an electrical resistor in thermal contact with the latter, in series with a switch, which is closed in response to said conditions.
At least one of said thresholds is as defined below:
   first threshold: about 80° C.
   second threshold: about 100° C.
   third threshold: about 110° C.
The second valve is of the thermostatic, electric or pneumatic type.

The characteristics and advantages of the invention will be explained in greater detail with reference to the drawings in the description which follows.

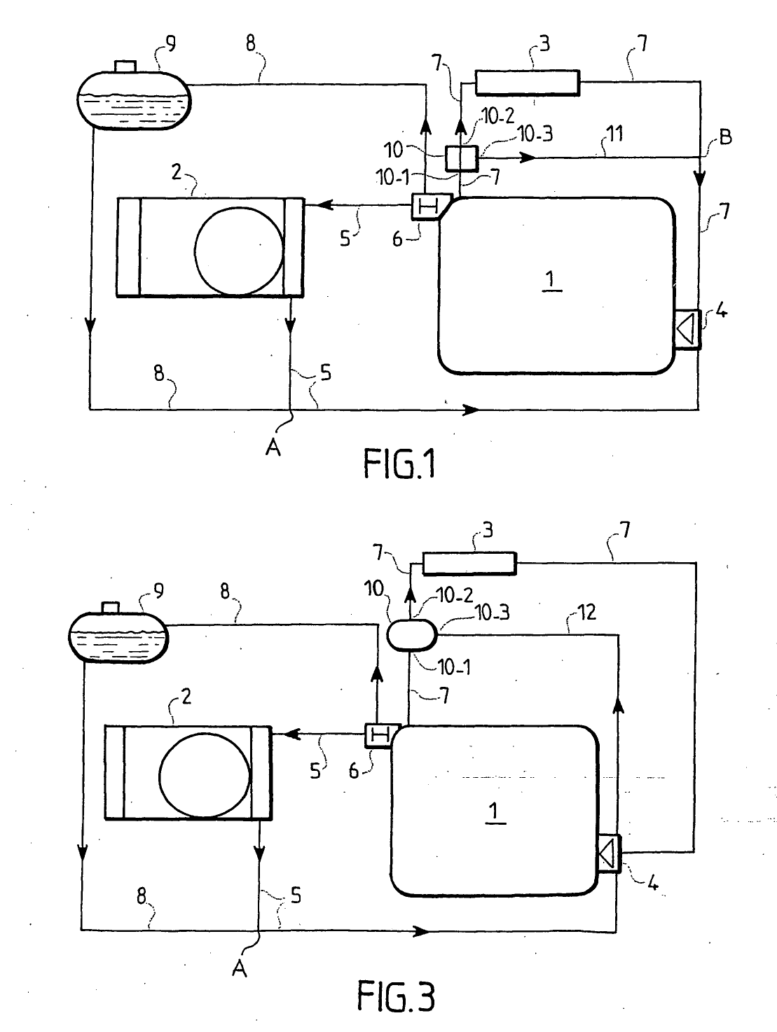

FIG. 1 is a schematic representation of a circuit containing heat transfer fluid in a device according to the invention.

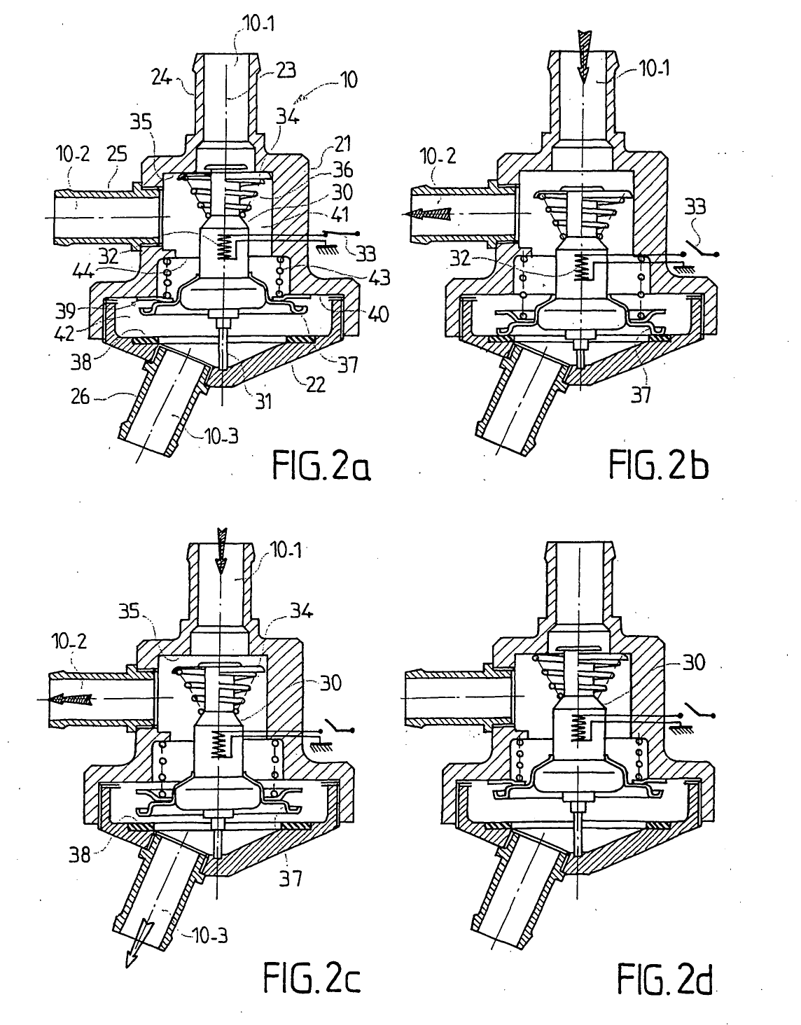

FIGS. 2a through 2d are sectional views of a three-way thermostatic valve belonging to the circuit of FIG. 1 for different temperatures of the fluid.

FIG. 3 is a representation similar to FIG. 1 relating to a modified circuit.

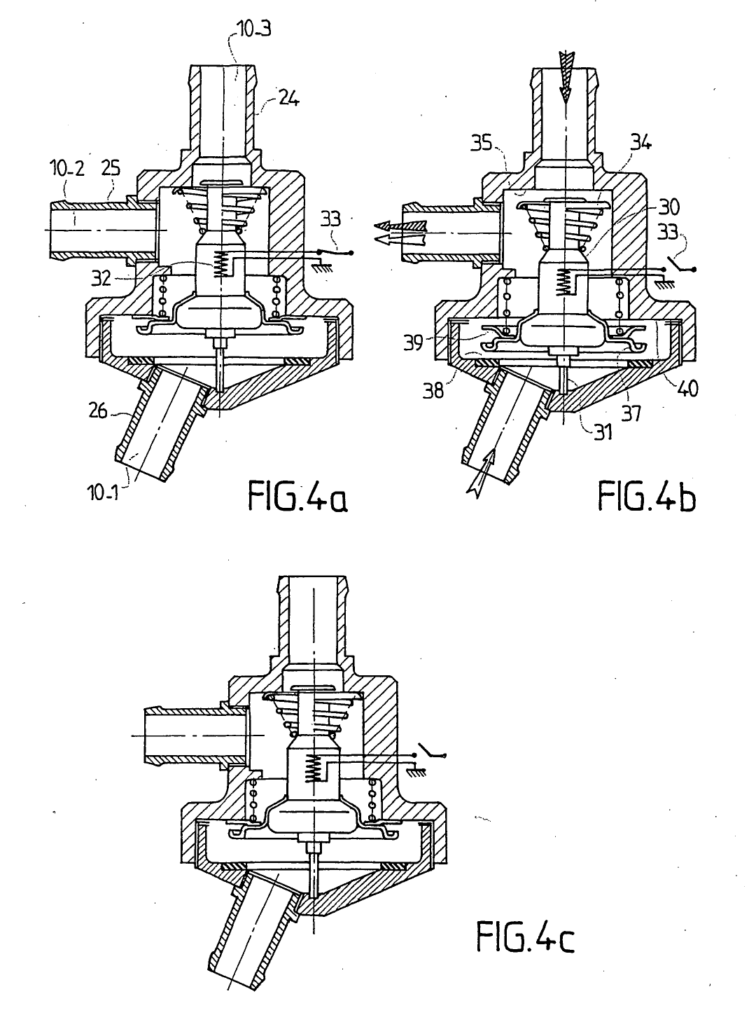

FIGS. 4a to 4c are views similar to FIGS. 2a through 2d, showing a valve that forms part of the circuit in FIG. 3.

Each of the circuits shown in FIGS. 1 and 3 comprises three main components, through which a heat transfer fluid can pass, namely the heat engine 1 for driving a motor vehicle, a radiator 2 provided to cool the engine 1, and a radiator 3 provided to heat the passenger compartment of the vehicle. In the conventional way, the circuit has, outside the engine, two main branches, in which the fluid can flow, being driven by a pump 4, which is, for example, electric, namely a first branch 5, which the fluid coming from the engine enters via a thermostatic valve 6, passing through the radiator 2 and ending at the pump 4, and a second branch 7, which starts from the engine, passes through the radiator 3 and likewise ends at the pump 4. Likewise in a conventional way, an additional branch 8 containing an expansion tank 9 starts from the outlet of the valve 6 and rejoins branch 5 at a connection point A situated downstream of the radiator 2.

In the circuit in FIG. 1, the pump 4 returns to the engine 1 all the fluid flowing in branches 5 and 7. Moreover, a three-way thermostatic valve 10 is interposed in branch 7, upstream of the radiator 3, and communicates via a conduit 11 with a connection point B situated in branch 7, downstream of the radiator 3. The inlet of the valve 10, which is connected to the engine 1, its outlet connected to the radiator 3, and its outlet connected to point B are respectively designated by the references 10-1, 10-2 and 10-3.

An exemplary embodiment of the valve 10 is shown in FIGS. 2a through 2d. This valve comprises a valve body formed in two pieces 21 and 22, substantially pieces of revolution about an axis 23, which are assembled with one another in a fluidtight manner. Piece 21 includes a connection piece 24 extending along the axis 23 and defining the inlet 10-1 of the valve. The outlets 10-2 and 10-3 are defined by connection pieces 25 and 26 respectively attached to pieces 21 and 22 and respectively extending perpendicularly to the axis 23 and obliquely to the latter. Disposed within the body 21, 22 is a bulb 30 containing a fluid substance with a high coefficient of thermal expansion, and in which a rod 31 can slide, the latter projecting from the bulb by a length that increases the higher the temperature of the fluid substance and consequently its volume. The rod 31 is fixed by its free end to piece 22 and extends along the axis 23 in such a way that the bulb 30 moves along this axis as a function of the temperature. An electrical resistor 32 connected to a voltage source via a switch 33 is placed within the bulb 30.

For convenience in the description, it is assumed that the valve 10 is aligned as shown in FIGS. 2a through 2d, the axis 23 being vertical, piece 22 being situated in the lower part and connection piece 24 being turned upward. The bulb 30 can thus move between an extreme lower position, shown in FIG. 2b, in which the rod 31 is retracted to the maximum extent, and an extreme upper position, shown in FIGS. 2a and 2d, in which the rod 31 is extended to the maximum extent.

The bulb 30 carries three shut-off elements in the form of profiled sheet-metal rings, which are bodies of revolution about the axis 23 and are each suitable for cooperating with a seat formed by a radially oriented annular surface of the body to close and open a passage for the fluid within the valve. A first shut-off element 34 cooperates with a downward-facing seat 35 formed in piece 21 below connection piece 24 and above connection piece 25. A conical spring 36 compressed axially between a shoulder of the bulb 30 and shut-off element 34, presses the latter against seat 34 in the top position of the bulb in such a way as to isolate inlet 10-1 from the interior of the valve. A shut-off element 37 cooperates with a seat 38 of piece 22, which seat faces upward and is situated higher than connection piece 26, in such a way as to isolate outlet 10-3 from the interior of the valve 10 in the bottom position of the bulb. Finally, a shut-off element 39 situated immediately above shut-off element 37 cooperates with a seat 40 formed in piece 21, which seat faces downward and faces seat 38, in such a way as to separate the interior of the valve, in the high position of the bulb, into an upper chamber communicating with channels 10-1 and 10-2 and a lower chamber 42 communicating with channel 10-3. In the example illustrated, shut-off element 37 is welded to the bulb 30 and shut-off element 39 is welded to the upper face of shut-off element 37. A helical spring 43, which is compressed axially between shut-off element 39 and an internal shoulder 44 of piece 21, assists the return of the bulb toward its low position.

The circuit in FIG. 1 operates in the following manner. When the engine 1 is started cold, the low temperature of the heat transfer fluid contained in the latter causes the thermostatic valve 6 to close in such a way that the fluid does not flow in branch 5 and consequently in the cooling radiator 2. Moreover, the switch 33 is jointly controlled as a function of the temperature of the fluid and of the demand for heating of the passenger compartment in such a way as to be closed only when the fluid is cold and there is no demand for heating. When the two conditions are satisfied, as shown in FIG. 2a, the closure of the switch 33 leads to the resistor 32 being supplied with power and to the substance contained in the bulb 30 being heated, moving the latter into its upper position, in which shut-off element 34 closes the inlet 10-1 connected to the engine. The fluid thus no longer flows in branches 7 and 11 and remains within the engine 1, hence ensuring that it heats up as quickly as possible. The pump 4 then idles.

If, on the contrary, heating of the passenger compartment is demanded, the switch 33 is open, as shown in FIG. 2b, such that the resistor 32 is not supplied with power and the bulb is held in a low position by the low temperature of the fluid. Outlet 10-3 is thus closed by shut-off element 37, while shut-off element 34 allows communication between inlet 10-1 and outlet 10-2. Thus the only throughput of fluid in circulation is that required in the radiator 3 to heat the passenger compartment.

When the temperature of the fluid in the engine reaches a value that allows the latter to operate in more or less optimum conditions, e.g. 80° C., the thermostatic valve 6 opens and the fluid flows in the cooling radiator 2. The same temperature threshold is used, at least approximately, to control the switch 33, such that the configuration of FIG. 2b, in which a maximum throughput flows in the heating radiator 3, is then obtained both in the case of a demand for heating and in the opposite case, the radiator 3 naturally not being swept by a flow of air in the latter case.

When the temperature of the fluid exceeds a second threshold, e.g. 100° C., the expansion of the substance contained in the bulb 30 due to it being immersed in the fluid causes it to rise, as shown in FIG. 2c. Shut-off element 37 then moves away from seat 38, opening outlet 10-3, such that the fluid entering the valve 10 via the inlet 10-1 is distributed between the outlet 10-2 leading to the radiator 3 and the outlet 10-3 returning to the pump 4, the throughput of fluid in the radiator 3 being a decreasing function of its temperature.

Finally, when the temperature of the heat transfer fluid reaches a third threshold, e.g. 110° C., the bulb 30 reaches its high position, as shown in FIG. 2d, preventing all flow of fluid in branches 7 and 11, as indicated above in relation to FIG. 2a. As the bulb 30 is raised (FIG. 2c), the cross section of passage between shut-off element 34 and its seat 35 decreases progressively, such that an increasing fraction of the throughput created by the pump 4 passes through the radiator 2, improving cooling efficiency. This efficiency is at its greatest in the position shown in FIG. 2d, which is only achieved in exceptional circumstances, for example when towing a heavy trailer such as a caravan up a long slope.

FIG. 3 shows an engine 1, a cooling radiator 2, a heating radiator 3, a branch 5, a thermostatic valve 6, a branch 8 and an expansion tank 9 similar to the elements designated by the same references in FIG. 1. Likewise, one branch 7 of the circuit runs from the outlet of the engine 1 to the pump 4, passing via a three-way valve 10 and via the radiator 3, the valve 10 being connected to the engine 1 by an inlet 10-1 and to the radiator 3 by an outlet 10-2. As a departure from FIG. 1, the third channel 10-3 of the valve 10 is an inlet, which is connected to the outlet of the pump 4 by a branch 12.

The structure of the valve 10 used in the circuit in FIG. 3, which is shown in detail in FIGS. 4a through 4c, is the same as that in FIGS. 2a through 2d, but the valve is connected differently, the channels 10-1, 10-2 and 10-3 being defined respectively by the connection pieces 26, 25 and 24.

The switch 33 associated with the resistor 32 is controlled as described above with reference to FIGS. 2a and 2b, such that, when the engine is cold and there is no demand for heating, the configuration in FIG. 4a, which is identical to that in FIG. 2a, is obtained, isolating channels 10-1 through 10-3 from each other and preventing any flow of fluid in branches 7 and 12.

In the valve in FIGS. 4a through 4c, the minimum length by which the rod 31 projects from the bulb 30 is greater than in the valve in FIGS. 2a through 2d, such that, in the lowest position that can be obtained by the bulb 30, the switch 33 being open and the engine being cold, shut-off element 37 is out of contact with seat 38 (FIG. 4b), allowing communication between channels 10-1 through 10-3 and flow of the fluid both in the radiator 3 and in branch 12.

Above the second temperature threshold (100° C.), the rod 31 emerges progressively from the bulb 30, lifting the latter and moving shut-off elements 34 and 39 closer to seats 35 and 40 respectively, reducing the throughput of the fluid entering via the inlet 10-1 from the engine and that entering via the inlet 10-3 from branch 12 and consequently the throughput of the fluid in the radiator 3, which is the sum of the above. These two shut-off elements close the corresponding passages (FIG. 4c) when the temperature of the fluid reaches or exceeds the third threshold (110° C.), such that all the flow produced by the pump 4 passes via the cooling radiator 2.

As indicated above, the valve shown in FIGS. 2a through 2d, which is used in the circuit in FIG. 1, and that shown in FIGS. 4a through 4c, which is used in the circuit in FIG. 3 are identical with the exception of the length of the rod 31. However, it will be noted that shut-off element 39 is not necessary to the operation of the circuit in FIG. 1 since, each time that it is closed (FIGS. 2a and 2d), shut-off element 34 is likewise closed, preventing any entry of fluid into the valve 10. Shut-off element 39 can therefore be omitted, the spring 44 resting directly on shut-off element 37. Likewise, shut-off element 37 is not necessary to the operation of the circuit in FIG. 3 since it never comes into contact with seat 38. Shut-off elements 37 and 39 can therefore be replaced by a single shut-off element fixed on the bulb 30 and coming into contact with seat 40 in the high position of the bulb.

Moreover, the three-way thermostatic valve can be of a type other than one employing an expanding substance in thermal contact with the heat transfer fluid. It can be an electrically controlled valve, for example.

Furthermore, the flow of the fluid in branch 7 and in the bypass branch 11 or 12 can be reversed relative to that shown in FIGS. 1 and 3, the inlets of the valve 10 becoming outlets and vice versa.

1. A device for cooling the heat engine (1) and heating the passenger compartment of a motor vehicle, comprising a first heat exchanger (2) suitable for contributing to a transfer of heat from a heat transfer fluid to the atmosphere, a second heat exchanger (3) suitable for contributing to a transfer of heat from the heat transfer fluid to the passenger compartment, a pump (4) suitable for making the fluid flow in the engine and in two branches (5, 7) in parallel respectively containing the first and second exchangers, and switching means (6, 10), which enable the fluid driven by the pump to flow or not to flow in each of said exchangers, the switching means comprising a first valve (6) suitable for preventing flow of the fluid in the first exchanger when its temperature is lower than a first threshold and for allowing it when said temperature is higher than the first threshold, characterized in that the switching means furthermore comprise a second valve (10) suitable for providing a cross section of passage for flow of the fluid in the second exchanger that depends on the temperature of the fluid: at its maximum below a second threshold higher than the first threshold and decreasing progressively between the second threshold and a third threshold higher than the latter, and zero above the third threshold.

2. The device as claimed in claim 1, in which the second valve is a three-way valve (10), in which said variable cross section of passage is situated between first and second channels (10-1, 10-2) connected respectively to the engine and the second exchanger, and is suitable for allowing a flow of fluid between the third channel (10-3), which is connected to a bypass conduit (11), and either the first or the second channel only when the temperature of the fluid is lower than the third threshold.

3. The device as claimed in claim 2, in which the flow of fluid between the third channel and either the first or the second channel is allowed only when the temperature of the fluid is between the second and third thresholds.

4. The device as claimed in claim 3, in which the first channel (10-1) is an inlet and the second and third channels (10-2, 10-3) are outlets or vice versa.

5. The device as claimed in claim 2, in which the flow of fluid between the third channel and either the first or the second channel is allowed even when the temperature of the fluid is lower than the second threshold.

6. The device as claimed in claim 5, in which the first and second channels (10-1, 10-2) are inlets and the third channel (10-3) is an outlet or vice versa.

7. The device as claimed in any of claims 2 through 6, in which the three-way valve has a movable member (30) which is displaced between extreme first and second positions when the temperature of the fluid varies between the second and third thresholds, said movable member including a first closing element (34), which isolates the first channel (10-1) from the two other channels (10-2, 10-3), and a second closing element (39), which isolates the third channel from the two other channels, in the second position, the closing elements opening the corresponding channels when not in the second position.

8. The device as claimed in claim 7, which is dependent on claim 3, in which the movable member includes a third closing element (37), which isolates the third channel from the two other channels in the first position and opens it when not in the first position.

9. The device as claimed in any of the preceding claims, in which the second valve is furthermore suitable for preventing flow of the fluid in the second exchanger (3) when the two following conditions are satisfied: temperature of the fluid lower than the first threshold and no demand for heating of the passenger compartment.

10. The device as claimed in claim 9, which is dependent on claim 7, in which the second valve contains a medium which is in thermal contact with the heat transfer fluid and the thermal expansion of which causes the displacement of the movable member, means (32, 33) being provided to heat said medium independently of the temperature of the fluid so as to move the movable member (30) into its second position in response to said two conditions.

11. The device as claimed in claim 10, in which the means for heating said medium comprise an electrical resistor (32) in thermal contact with the latter, in series with a switch (33), which is closed in response to said conditions.

12. The device as claimed in any of the preceding claims, in which at least one of said thresholds is as defined below:
first threshold: about 80° C.
second threshold: about 100° C.
third threshold: about 110° C.

13. The device as claimed in any of the preceding claims, in which the second valve (10) is of the thermostatic, electric or pneumatic type.
